(19) United States
(12) Patent Application Publication
(10) Pub. No.: US 2007/0200077 A1
(43) Pub. Date: Aug. 30, 2007

(54) Exhausting and decompressing device of sphygmomanometer

(75) Inventor: S.J. Wu Tower, Taipei (TW)

Correspondence Address: HDSL, 4331 STEVENS BATTLE LANE, FAIRFAX, VA, 22033, US

(73) Assignee: Rossmax International Ltd.

(21) Appl. No.: 11/362,342

(22) Filed: Feb. 27, 2006

(51) Int. Cl. F16K 31/08

(52) U.S. Cl. 251/65; 251/129.15

(57) ABSTRACT

An exhausting and decompressing device of a sphygmomanometer, suitable for communicating with the wristband/armband of the sphygmomanometer, includes a casing having a hollow accommodating space, a valve nozzle provided at one end of the casing for communicating with the accommodating space, and a movable member and a magnetic element provided within the casing. The movable member includes a base body, a valve and a magnetic body. The magnetic body is provided to correspond to the magnetic element. A gap groove is formed between the magnetic element and the base. A coil is provided within the gap groove. One end of the coil is connected to the underside of the base body of the movable member. The opening/closing between the valve of the movable member and the valve nozzle of the casing can be controlled by the interactions among the magnetic element, the magnetic body and the magnetizing coil.

### BACKGROUND OF THE INVENTION

1. Field of the Invention

The present invention relates to an exhausting and decompressing device of a sphygmomanometer, and in particular, to an exhausting and decompressing device capable of being communicated with a wristband and/or armband of the sphygmomanometer to measure the blood pressure.

2. Description of Prior Art

The conventional exhausting and decompressing device of a sphygmomanometer, as disclosed in Taiwan Patent Publication No. 341115, comprises a casing, a cover, a valve plate, a movable member, an electromagnet, a coil and a spring. The top end of the casing is provided with a plurality of venting holes. The upside of the casing is connected to the valve plate and the cover. The central portion of the valve plate is provided with a venting hole. Two valve nozzles are provided on the cover. Each of the valve nozzles is connected to an inflating tube and a wristband, respectively. The central portion of the casing is provided with a recessed accommodating groove for accommodating the electromagnet and the movable member. The movable member is provided with a step-like shaft rod and a valve connected to the shaft rod. The bottom surface of the movable member is provided with the coil. The outer periphery of the valve is provided with the spring. Both ends of the spring abut against the bottom surface of the valve plate and the end face of the shaft rod corresponding to the valve plate, respectively. With the above arrangement, a decompressing device can be formed.

Although the conventional exhausting and decompressing for a sphygmomanometer has the effect of exhausting and decompressing, in practice, it still exists some problems as follows. Since the opening/closing action between the valve and the venting hole of the valve plate is controlled by the electromagnet and the elastic action of the spring, the long-term operation can cause the spring to produce elastic fatigue or uneven force to deflect to one side, thereby to cause the poor intake and exhaustion of the decompressing device. Further, the valve plate is provided between the valve and the valve nozzle, so that the external dimension of the decompressing device cannot be effectively minimized, which does not conform to the tendency towards compactness and minimization. Further, no matter when the spring is under manufacture or heat treatment, the tensile strength for resisting the compression (or tension) of each spring cannot be precisely controlled, which causes the unevenness in the quality of the decompressing device after assembling. Further, the constituent elements of the above conventional device are so many that it is complicated in structure, causing a time-consuming and inconvenient assembling. As a result, the manufacture cost cannot be effectively reduced.

### SUMMARY OF THE INVENTION

The present invention is to provide an exhausting and decompressing device of a sphygmomanometer, which can significantly reduce the external dimension of the decompressing device, overcome the elastic fatigue and uneven quality of the spring, achieve the minimization of the device and reduce the material cost.

Accordingly, the present invention provides an exhausting and decompressing device of a sphygmomanometer capable of being communicated with a wristband and/or armband of the sphygmomanometer. The device comprises a casing having a hollow accommodating space, one side thereof provided with a valve nozzle in communication with the accommodating space; a movable member provided within the accommodating space of the casing, the movable member comprising a base body, a valve connected to the base body to correspond to the valve nozzle of the casing, and a magnetic body connected to the base body; a magnetic element also provided within the accommodating space of the casing, a gap groove provided between the magnetic element and the wall face of the casing, the magnetic element provided to correspond to the magnetic body of the movable member for departing the valve of the movable member from the valve nozzle of the casing; and a coil provided in the gap groove with one end thereof connected to one side of the base body of the movable member, wherein the opening/closing between the valve of the movable member and the valve nozzle of the casing can be controlled by the interactions among the magnetic element, the magnetic body and the magnetizing coil.

### BRIEF DESCRIPTION OF THE DRAWINGS

FIG. 1 is an exploded perspective view of a first embodiment of the present invention;

FIG. 2 is a longitudinal sectional view showing the assembling of the first embodiment of the present invention;

FIG. 3 is a cross-sectional view taken along the line 3-3 of FIG. 2;

FIG. 4 is a cross-sectional view (I) showing the state in which the present invention is used, in open status;

FIG. 5 is a cross-sectional view (II) showing the state in which the present invention is used, in close status;

FIG. 6 is a cross-sectional view showing the assembling of the second embodiment of the present invention; and

FIG. 7 is a cross-sectional view showing the assembling of the third embodiment of the present invention.

### DETAILED DESCRIPTION OF THE INVENTION

The characteristics and the technical contents of the present invention will be explained with reference to the detailed description and the accompanying drawings. However, it should be understood that the drawings are illustrative but not used to limit the scope of the present invention.

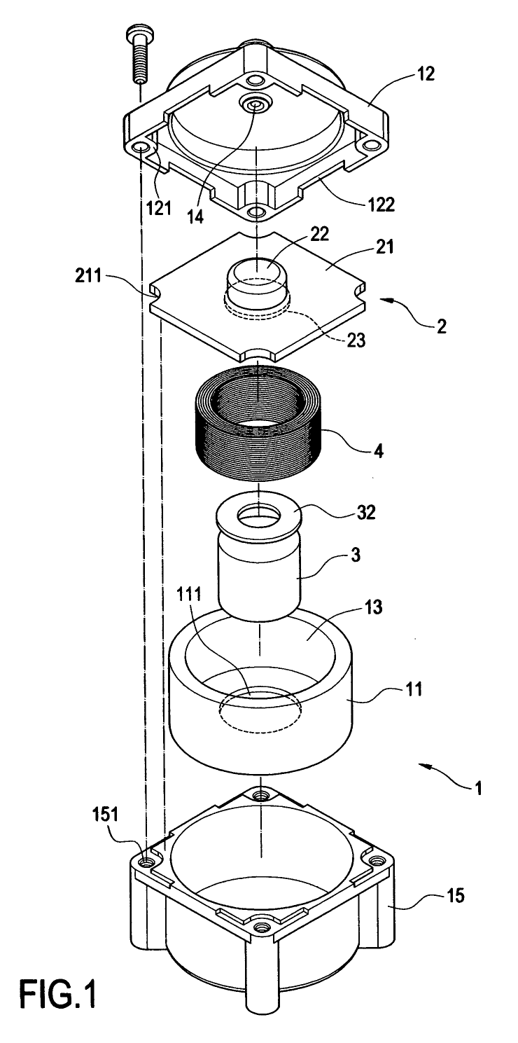

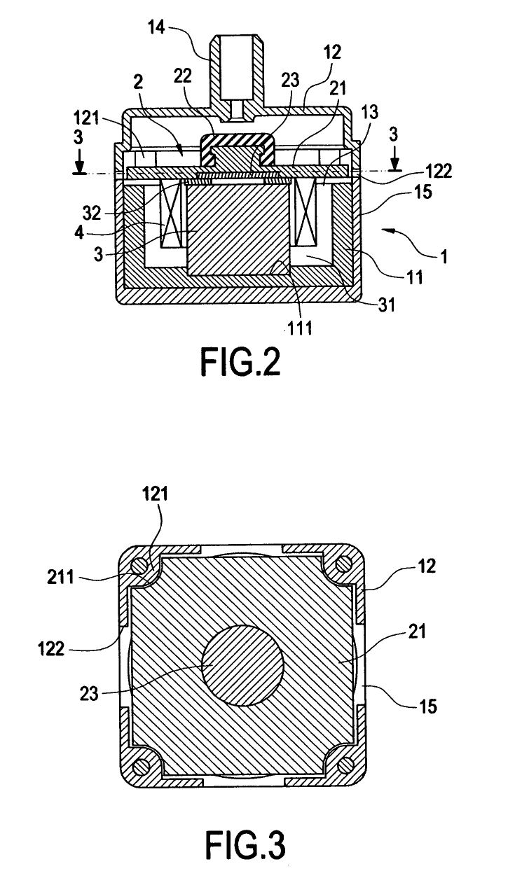

FIG. 1 is an exploded perspective view of a first embodiment of the present invention. FIG. 2 is a longitudinal sectional view showing the assembling of the first embodiment of the present invention. FIG. 3 is a cross-sectional view taken along the line 3-3 of FIG. 2. The present invention provides an exhausting and decompressing device of a sphygmomanometer, which comprises a casing 1, a movable member 2, a magnetic element 3 and a coil 4.

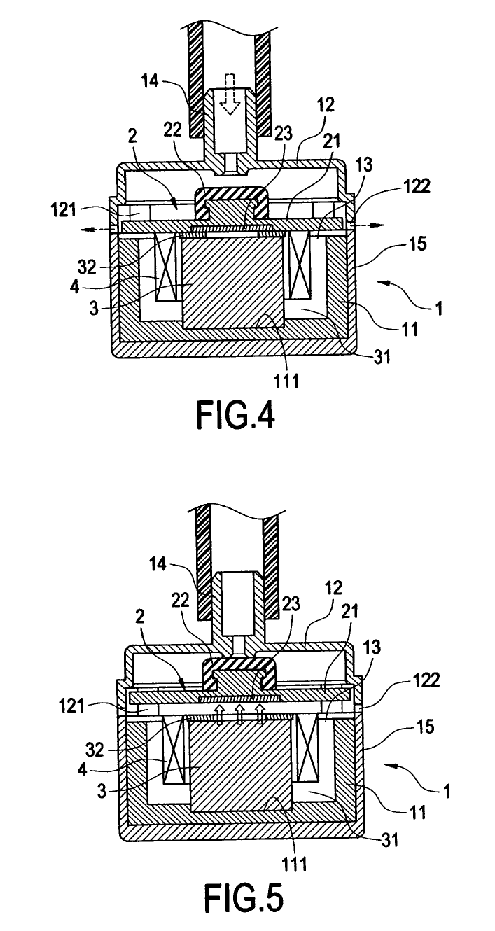

The casing 1 is formed of a base 11 and a cover 12 correspondingly covering over the base 11. The base 11 can be made by a metallic material, and formed with a bottomed cylindrical body, U-shaped plate or other different constructions. In the present embodiment, a cylindrical body is used. The interior of the base is formed with a hollow accommodating space 13. The cover 12 can be made by a plastic material, and formed with guiding rails 121 at four comers. A plurality of venting grooves 122 is provided on the longitudinal plates of the cover. The center of the cover 12 is provided with a valve nozzle 14 in communication with the accommodating space 13. The exterior of the valve nozzle 14 can be connected to an inflating tube (as shown in FIG. 4). In addition, the casing 1 of the present embodiment comprises an outer cover 15. The outer cover 15 covers the exterior of the base 11 and is provided with a plurality of screw holes 151 at four comers. The screw holes 151 are used for fastening the cover 12 by means of screws.

The movable member 2 is provided within the accommodating space 13 of the casing 1. The movable member comprises a base body 21, a valve 22 connected to the upside of the base body 21 to correspond to the valve nozzle 14 of the cover 12, and a magnetic body 23 connected to the underside of the base body 21. In the present embodiment, the base body 21 is formed into a rectangular plate with guiding grooves 211 at four corners. The guiding grooves 211 correspondingly mate with the guiding rails 121 of the cover 12 for guiding and positioning the up-and-down movement of the base 21. The valve can be made by rubber, silicone or the like and formed into a circular shape. The magnetic body 23 can be made by suitable magnetic material that having large volume but weak magnetic force (such as plastic magnet); having small volume but strong magnetic force (such as steel bead), or other similar material that could be attracted by the magnetic force

The magnetic element 3 is also provided within the accommodating space 13 of the casing 1, and it can be a permanent magnet. An annular gap groove 31 (as shown in FIG. 2) is formed between the magnetic element 3 and the wall face of the casing 11. The end face of the magnetic element 3 is provided to correspond to the end face of the magnetic body 23. Normally, the action force for driving the valve 22 to return to its initial position is the magnetic attraction between the magnetic element 3 and the magnetic body 23. As a result, the valve 22 of the movable member 2 can be departed form the valve nozzle 14 of the cover 12, which is referred to the normal open state. Further, in order to integrate the magnetic lines of force of the magnetic element 3, an annular iron pad 32 can be provided between the contacting end faces of the magnetic body 23 and the magnetic element 3. Normally, the magnetic element is connected to the magnetic body 23 of the movable member 2 via the pad 32 in an indirect attracted manner.

The coil 4 is provided in the gap groove 31 formed between the magnetic element 3 and the accommodating space 13 of the base 11. One end of the coil 14 is connected to the underside of the base body 21 of the movable member 2.

FIGS. 4 and 5 are cross-sectional views (I) and (II) showing the state in which the present invention is used, respectively. When the electric current is not introduced into the coil 4, the magnetic body 23 drives the movable member 2 to move toward the magnetic element 3 due to the magnetic attraction between the magnetic element 3 and the magnetic body 23. As a result, the valve 22 moves to the side away from the valve nozzle 14, so that the valve nozzle 14 and the valve 22 can be kept in an unobstructed state to facilitate the exhaustion of the fluid from each venting groove 122 of the cover 12 (as shown in FIG. 4). On the contrary, when the electric current is introduced into the coil 4, a magnetically pushing force is produced between the coil 4 and the magnetic element 3. When this pushing force is larger than the entering pressure of the fluid and the magnetic attraction between the magnetic element 3 and the magnetic body 23, the coil 4 drives the movable member 2 to move away from the magnetic element 3, so that the valve 22 can abut against the valve nozzle 14 to achieve the sealing (as shown in FIG. 5).

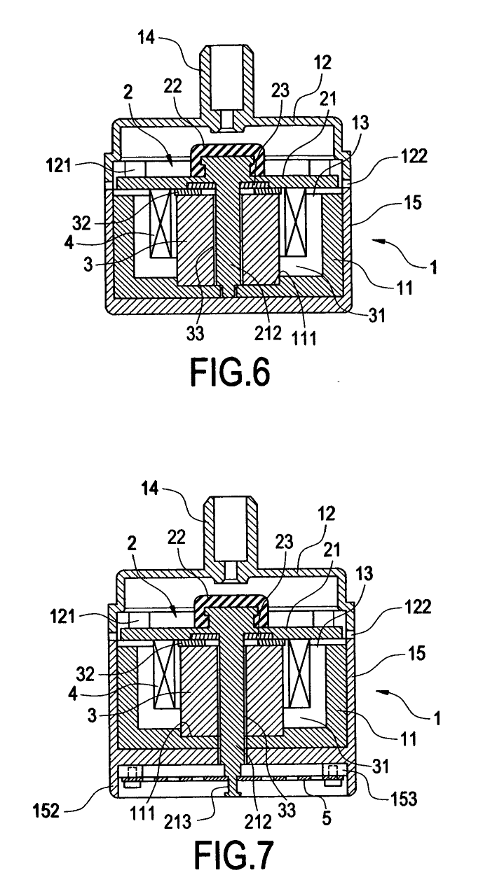

FIG. 6 is a cross-sectional view showing the assembling of the second embodiment of the present invention. In addition to the construction of the above embodiment, the base body 23 of the movable member 2 in the present embodiment can be provided with a shaft rod 212 extending downwardly from the center of the underside of the base body 21. The root of the shaft rod 212 is connected to an annular magnetic body 23. Further, the center of the magnetic element 3 is formed with a through hole 33. The shaft rod 212 penetrates the through hole 33 to increase the stability in the up-and-down movement of the movable member 2.

FIG. 7 is a cross-sectional view showing the assembling of the third embodiment of the present invention. In this embodiment, the end portion of the shaft rod 212 of the second embodiment extends downwardly to a further extent, so that a positioning section 213 is provided on the distal end thereof. Further, the outer periphery of the bottom of the outer cover 15 is provided with a hollow extension 152. The inner periphery of the extension 152 is formed with a fixing ring 153 for fixing the outer periphery of a positioning piece 5. The center of the positioning piece 5 is connected into the positioning section 213 of the shaft rod 212 to increase the stability in the up-and-down movement of the shaft rod 212.

According to the above, the exhausting and decompressing device of a sphygmomanometer of the present invent has industrial applicability, novelty and inventive steps. Further, since the construction of the present invention has not been published or put to public use prior to applying for patent, the present invention indeed conforms to the requirements for a utility model patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. An exhausting and decompressing device of a sphygmomanometer, comprising:
a casing having a hollow accommodating space, one side thereof provided with a valve nozzle in communication with the accommodating space;
a movable member provided within the accommodating space of the casing, the movable member comprising a base body, a valve connected to the base body to correspond to the valve nozzle of the casing, and a magnetic body connected to the base body;
a magnetic element also provided within the accommodating space of the casing, a gap groove provided between the magnetic element and the wall face of the casing, the magnetic element provided to correspond to the magnetic body of the movable member for departing the valve of the movable member from the valve nozzle of the casing; and
a coil provided in the gap groove with one end thereof connected to one side of the base body of the movable member, wherein the opening/closing between the valve of the movable member and the valve nozzle of the casing can be controlled by the interactions among the magnetic element, the magnetic body and the magnetizing coil.

2. The exhausting and decompressing device of a sphygmomanometer according to claim 1, wherein the casing comprises a base and a cover correspondingly covering over the base, and the accommodating space is formed in the region enclosed by the base and the cover.

3. The exhausting and decompressing device of a sphygmomanometer according to claim 2, wherein the casing further comprises an outer cover covering the outside of the base, and the top face of the outer cover is provided with a plurality of screw holes for fastening the cover by screws.

4. The exhausting and decompressing device of a sphygmomanometer according to claim 2, wherein the inside of the cover is formed a plurality of guiding rails, respectively, and the periphery of the base body of the movable member is provided with a plurality of guiding grooves corresponding to the guiding rails for guiding and positioning the up-and-down movement of the base body.

5. The exhausting and decompressing device of a sphygmomanometer according to claim 1, wherein the action force for driving the valve to return to its initial position is the magnetic attraction between the magnetic element and the magnetic body.

6. The exhausting and decompressing device of a sphygmomanometer according to claim 1, wherein the valve and the magnetic body are connected to the opposite sides of the base body, respectively.

7. The exhausting and decompressing device of a sphygmomanometer according to claim 1, wherein the valve of the movable member is made from any one of rubber or silicone.

8. The exhausting and decompressing device of a sphygmomanometer according to claim 1, wherein the magnetic body of the movable member is made from material that having large volume but weak magnetic force or having small volume but strong magnetic force.

9. The exhausting and decompressing device of a sphygmomanometer according to claim 1, wherein a shaft rod extends downwardly from the bottom of the base body of the movable member, the center of the magnetic element is provided with a through hole, and the shaft rod penetrates the through hole for guiding the up-and-down movement of the movable member.

10. The exhausting and decompressing device of a sphygmomanometer according to claim 9, wherein the distal end of the shaft rod is provided with a positioning section, an extension projects outwardly from the bottom of the casing, the inside of the extension is formed with a fixing ring for fixing the outer periphery of a positioning piece, and the center of the positioning piece is connected into the positioning section of the shaft rod.

11. The exhausting and decompressing device of a sphygmomanometer according to claim 1, wherein the magnetic element is a permanent magnet.

12. The exhausting and decompressing device of a sphygmomanometer according to claim 1, wherein the magnetic element comprises a iron pad provided on the corresponding end faces of the magnetic element and the magnetic body of the movable member.
